(19) United States
(12) Patent Application Publication
(10) Pub. No.: US 2013/0227606 A1
(43) Pub. Date: Aug. 29, 2013

(54) SERVER APPARATUS AND TERMINAL APPARATUS

(71) Applicant: Panasonic Corporation, (US)

(72) Inventors: Hiroki INAGAKI, Kyoto (JP); Yoshiki KUNO, Osaka (JP)

(73) Assignee: Panasonic Corporation, Osaka (JP)

(21) Appl. No.: 13/654,721

(22) Filed: Oct. 18, 2012

(30) Foreign Application Priority Data
Feb. 28, 2012 (JP) 2012-041645

(51) Int. Cl. H04N 21/80

(52) U.S. Cl. 725/33

(57) ABSTRACT

In a server apparatus delivering emergency information to a client, a delivery settings management section manages delivery settings of the emergency information for each of registered clients. When an input receives an emergency information item, a client identifying section refers to the delivery settings managed by the delivery settings management section, and identifies, among the registered clients, the client to which the emergency information item received by the input is to be delivered. A transmitter sends the emergency information item to the client identified by the client identifying section.

### CROSS-REFERENCE TO RELATED APPLICATION

This application claims priority to Japanese Patent Application No. 2012-041645 filed on Feb. 28, 2012, the disclosure of which including the specification, the drawings, and the claims is hereby incorporated by reference in its entirety.

### BACKGROUND

The present disclosure relates to server apparatuses sending emergency information to clients.

Japanese Patent Publication No. 2004-72439 teaches displaying a caption to be superimposed on a reproduced image during time-free reproduction upon receipt of a closed-captioned broadcast so that a user can see the caption in real time.

### SUMMARY

The present disclosure provides a server apparatus advantageous in delivering input emergency information to a client of a user, who wishes to receive the information.

The server apparatus according to an aspect of the present disclosure, which delivers emergency information to a client, includes a delivery settings management section configured to manage delivery settings of the emergency information for each of registered clients; an input configured to receive an emergency information item; a client identifying section configured to refer to the delivery settings managed by the delivery settings management section, and to identify, among the registered clients, the client to which the emergency information item received by the input is to be delivered; and a transmitter configured to send the emergency information item to the client identified by the client identifying section.

A server apparatus according to another aspect of the present disclosure includes a broadcast receiver configured to receive a digital broadcast signal; a separator configured to separate a stream of a predetermined type from the digital broadcast signal; a multiplexer configured to multiplex the stream of the predetermined type separated by the separator with another stream different from the digital broadcast signal; and a network transmitter configured to send the stream multiplexed by the multiplexer over a wired or wireless network.

A terminal apparatus according to an aspect of the present disclosure receives a multiplexed stream from the server apparatus and reproduces the multiplexed stream. The terminal apparatus includes a network receiver configured to receive the multiplexed stream from a wired or wireless network; and a superimposer configured to superimpose a stream of a predetermined type on a display image of the multiplexed stream received by the network receiver.

The server apparatus according to the present disclosure is advantageous in delivering input emergency information to a client, or a user, who wishes to receive the information.

### BRIEF DESCRIPTION OF THE DRAWINGS

FIG. 1 illustrates a configuration of a server apparatus according to an embodiment.

FIGS. 2A-2C illustrate how to demultiplex TS data.

FIG. 3 illustrates a configuration of a client terminal according to the embodiment.

FIG. 4 illustrates an example display screen on which a caption is superimposed.

FIG. 5 is a configuration variation of the server apparatus of FIG. 1.

FIG. 6 is another configuration variation of the server apparatus of FIG. 1.

FIG. 7 illustrates a configuration of a server apparatus according to another embodiment.

FIGS. 8A and 8B illustrate example delivery settings managed by a delivery settings management section.

FIG. 9 illustrates an example delivery settings screen of a terminal apparatus.

FIG. 10 is a flow chart illustrating example operation of a server apparatus.

FIG. 11 illustrates an example screen to which emergency information is delivered.

FIG. 12 illustrates a configuration of a server apparatus according to a combination of the embodiments.

### DETAILED DESCRIPTION

Embodiments are described in detail below with reference to the attached drawings. However, unnecessarily detailed description may be omitted. For example, detailed description of well known techniques or description of the substantially same elements may be omitted. Such omission is intended to prevent the following description from being unnecessarily redundant and to help those skilled in the art easily understand it.

Inventors provide the following description and the attached drawings to enable those skilled in the art to fully understand the present disclosure. Thus, the description and the drawings are not intended to limit the scope of the subject matter defined in the claims.

### First Embodiment

Conventionally, superimposition has been used, which displays character information (a caption) such as urgent breaking news on a natural disaster to be superimposed on a background image in a digital television broadcast.

Japanese Patent Publication No. 2004-72439 teaches superimposing a caption, which has been detected from a digital broadcast signal, on an image displayed after decoding the digital broadcast signal. This enables a user of equipment having the function of receiving digital broadcasts to receive urgent breaking news on a natural disaster even in time-free reproduction. However, the urgent breaking news on the natural disaster are not delivered to equipment not having the function of receiving digital broadcasts, and thus the user of such equipment cannot receive the emergency information.

### Server Apparatus

FIG. 1 illustrates the configuration of a server apparatus according to this embodiment. A server apparatus 100 of FIG. 1 includes a broadcast receiver 101, a TS demultiplexer 102, a storage medium 103, a TS multiplexer 104, and a network transmitter 105.

The broadcast receiver 101 is a tuner for receiving digital broadcasts. The broadcast receiver 101 receives a digital broadcast signal, demodulates and descrambles the signal to decode it to transport stream data (hereinafter referred to as TS data), and outputs the data to the TS demultiplexer 102.

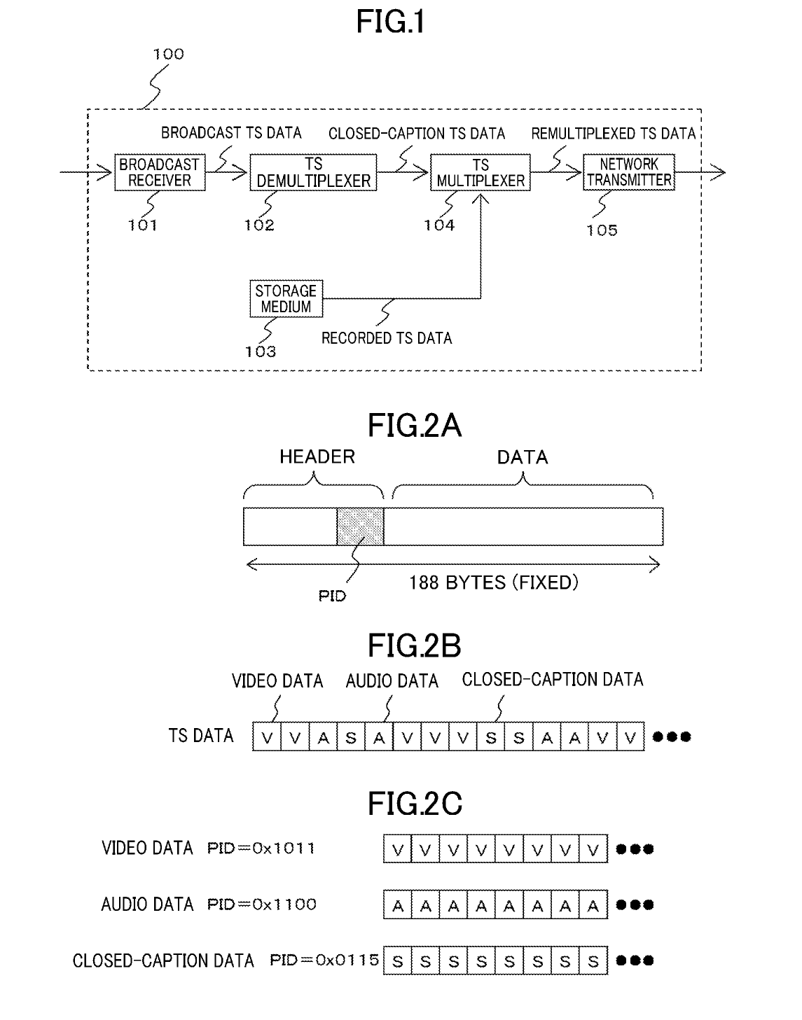

FIGS. 2A-2C illustrate how to demultiplex TS data. FIG. 2A illustrates a TS packet with a fixed length (188 bytes), which is a fundamental unit of the TS data. Each TS packet includes a header at the head, and data following the header. A packet identification number called a packet ID (PID) is assigned to each packet, and is included in the header. Upon receipt of the TS data, the PID identifies to which group the TS packet belongs. For example, as shown in FIG. 2B, where video TS packets (hereinafter referred to as V), audio TS packets (hereinafter referred to as A), and closed-caption TS packets (hereinafter referred to as S) are mixed in TS data, identifiers uniquely identifying the types of the packets are assigned. For example, the PID of a video TS packet is 0x1011, the PID of an audio TS packet is 0x1100, and the PID of a closed-caption TS packet is 0x0115. Using the PIDs, the video, audio, and closed-caption TS packets can be separated as shown in FIG. 2C.

In addition to video data, audio data, a subtitle, a data broadcast, and closed-caption data; TS data used in a digital broadcast includes program specific information (PSI), a program association table (PAT), a program map table (PMT), a network information table (NIT), a conditional access table (CAT), service information (SI), etc., which associate various information items attached to TS data.

Referring back to FIG. 1, the TS demultiplexer 102 checks the PIDs of broadcast TS data sent from the broadcast receiver 101, extracts only a TS packet having a PID associated with a caption to generate closed-caption TS data, and outputs the closed-caption TS data to the TS multiplexer 104.

The storage medium 103 is, for example, an HDD, which stores video TS data captured in a digital broadcast or by a video camera. The storage medium 103 is not limited to an HDD, but may be an SSD or a removable storage medium such as an SD card, which can be used by inserting to a drive, an USB memory, an USB-HDD, and a Blu-ray media, as long as data can be stored. The data stored in the storage medium 103 is not limited to TS data captured in a digital broadcast or by a video camera, but may be multimedia contents in other formats, which may be, for example, photograph data, music data, contents downloaded from the network, etc.

The TS multiplexer 104 multiplexes the closed-caption TS data sent from the TS demultiplexer 102 with the TS data output from the storage medium 103 on a TS packet-by-TS packet basis, and outputs the multiplexed data to the network transmitter 105.

The network transmitter 105 converts remultiplexed TS data, which has been multiplexed by the TS multiplexer 104, into a format in which data can be sent over the network. The network transmitter 105 sends the converted data to a wired or wireless network using a transmission protocol such as digital living network alliance (DLNA). The storage medium 103 may store broadcast data received by the broadcast receiver 101.

The inner configuration of the server apparatus 100 can be modified. For example, the broadcast receiver 101 is not limited to a tuner for receiving digital broadcasts. The server apparatus 100 may be connected to a set top box (STB) via Ethernet (registered trademark), iLINK, etc., and may receive broadcast TS data from such a connecting terminal.

The TS data extracted by the TS demultiplexer 102 is not limited to a caption, but may be any type of data such as video data, audio data, a subtitle, a data broadcast, etc., which delivers urgent breaking news, as long as it is included in the TS data. In this case, for example, a unique PID is assigned to TS data on emergency information, thereby separating the TS data from the other pieces of TS data. For example, the TS demultiplexer 102 may separate a TS packet assigned with a PID indicating emergency information from other TS packets which are captions. In this case, the emergency information includes, for example, a flash report on or a warning about a natural disaster.

While the broadcast receiver 101 obtains TS data of a plurality of digital broadcast channels, a user may select, from which channel the TS data is received.

Where TS data is sent to a plurality of terminal apparatuses at the same time, the terminal apparatuses may receive the TS data from different channels, or the TS data may be sent to all the terminal apparatuses from the same channel. The terminal apparatuses and the channels may be in any combination.

### Terminal Apparatus

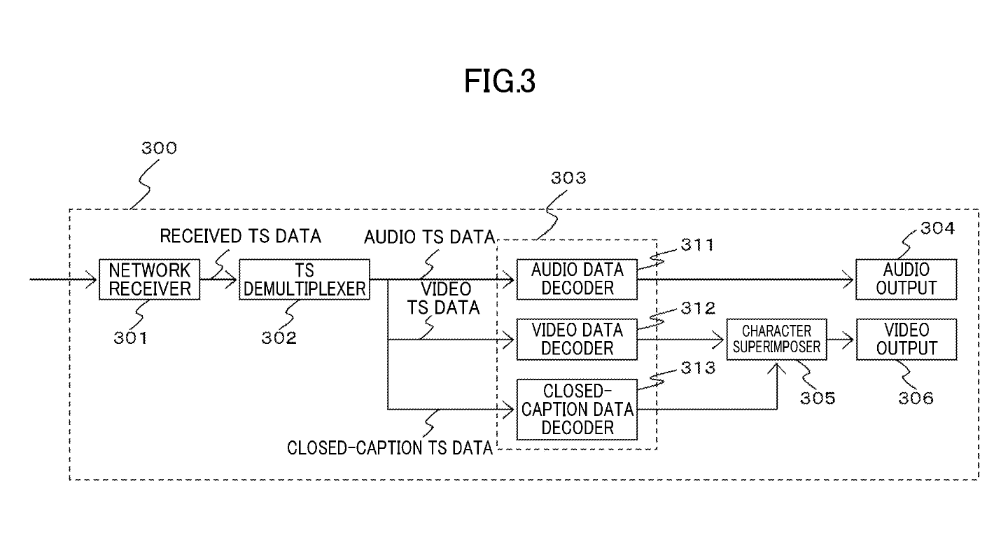

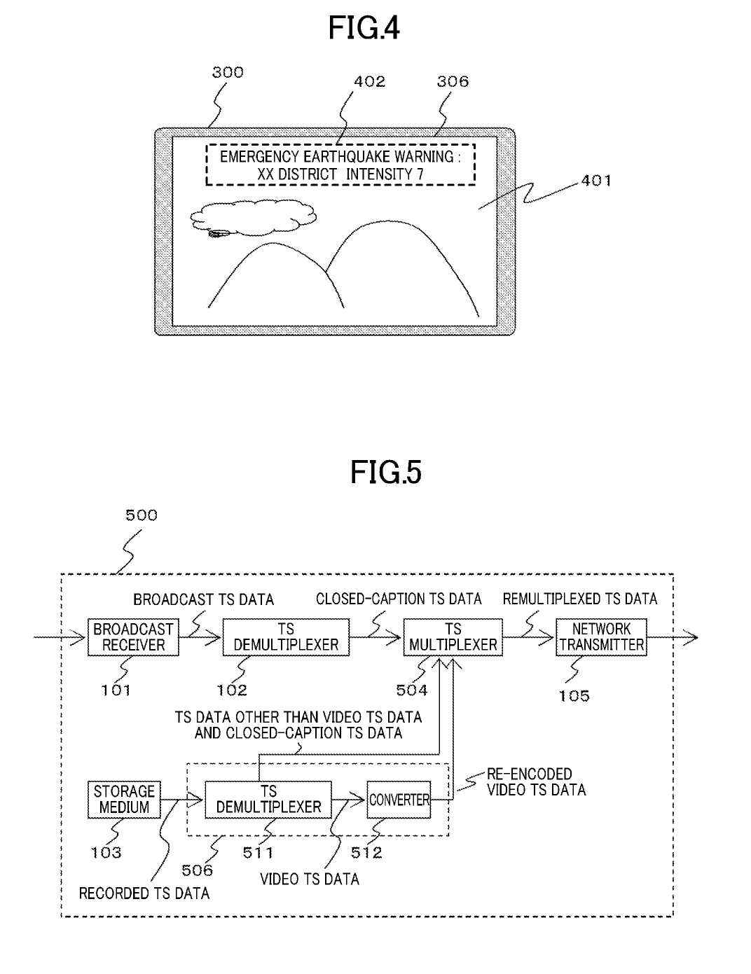

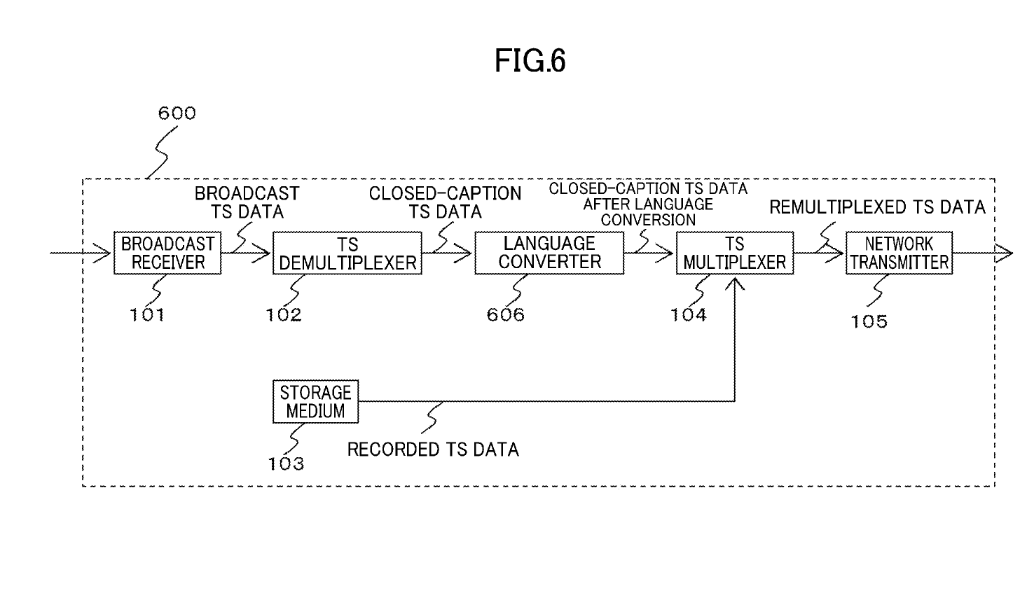

FIG. 3 illustrates the configuration of a terminal apparatus according to this embodiment. A terminal apparatus 300 of FIG. 3 includes a network receiver 301, a TS demultiplexer 302, a TS decoder 303, an audio output 304, a character superimposer 305, and a video output 306. The TS decoder 303 includes an audio data decoder 311, a video data decoder 312, and a closed-caption data decoder 313.

The network receiver 301 receives data sent over a wired or wireless network, decodes the received data to TS data, and outputs the TS data to the TS demultiplexer 302.

Similar to the TS demultiplexer 102 of the server apparatus 100, the TS demultiplexer 302 checks the PIDs of TS packets included in the TS data, separates the TS data based on the PIDs, and outputs the TS data to the TS decoder 303. At this time, the TS data having a PID indicating audio data is output to the audio data decoder 311. The TS data having a PID indicating video data is output to the video data decoder 312. The TS data having a PID indicating closed-caption data is output to the closed-caption data decoder 313. The types of the TS data input to the TS demultiplexer 302 are not limited to audio data, video data, and closed-caption data, but other types of data may be included.

The TS decoder 303 performs decoding of the TS data having the PIDs, which has been separated by the TS demultiplexer 302. The audio data decoder 311 decodes audio TS data to generate baseband audio data, and outputs the generated data to the audio output 304. The video data decoder 312 decodes video TS data to generate baseband video data, and outputs the generated data to the character superimposer 305. The closed-caption data decoder 313 decodes closed-caption TS data to generate baseband character data, and outputs the generated data to the character superimposer 305.

The audio output 304 is, for example, an audio output terminal, and is connected to headphones etc. to hear a sound. The character superimposer 305 superimposes the character data on the baseband video data, and outputs, to the video output 306, the video data on which the characters are superimposed. The video output 306 is, for example, a display of a terminal. Video data is displayed on the display. FIG. 4 illustrates an example where an image obtained by superimposing closed-caption character data 402 on video data 401 is displayed on the video output 306 of the terminal apparatus 300.

In this embodiment, if there is a caption, the caption is necessarily superimposed on an image. However, whether or not to superimpose a caption may be selected by user operation.

### Advantages Etc.

As described above, in this embodiment, the server apparatus 100 includes the broadcast receiver 101, the TS demultiplexer 102, the TS multiplexer 104, and the network transmitter 105. The broadcast receiver 101 receives a digital broadcast signal. The TS demultiplexer 102 separates a stream of a predetermined type, for example, closed-caption TS data, from the digital broadcast signal. The TS multiplexer 104 multiplexes the separated closed-caption TS data with another TS data different from the digital broadcast signal. The network transmitter 105 sends the multiplexed TS stream over a wired or wireless network. As a result, the terminal apparatus 300 obtains the stream of the predetermined type, for example, closed-caption TS data, included in a digital broadcast even without receiving the digital broadcast. Therefore, for example, the terminal apparatus 300 displays a caption indicating emergency information including a flash report on or a warning about a natural disaster.

### Variation

FIG. 5 illustrates a variation of the partial configuration of the server apparatus of FIG. 1. A server apparatus 500 of FIG. 5 includes a broadcast receiver 101, a TS demultiplexer 102, a storage medium 103, a TS multiplexer 504, a network transmitter 105, and a data converter 506. The data converter 506 includes a TS demultiplexer 511 and a converter 512.

The data converter 506 converts TS data stored in the storage medium 103, and outputs the converted data to the TS multiplexer 504. The TS demultiplexer 511 checks the PIDs of the TS data output from the storage medium 103, and separates the TS data based on the PIDs. The TS demultiplexer 511 outputs video TS data to the converter 512, and the TS data other than the video TS data and closed-caption TS data to the TS multiplexer 504. The converter 512 converts the video TS data sent from the TS demultiplexer 511 to an elementary stream (ES), decodes the elementary stream to baseband video data, and outputs the re-encoded TS data to the TS multiplexer 504. At this time, for example, the bit rate of data is reduced in accordance with the bandwidth of the network, thereby enabling smooth, uninterrupted transmission. The TS multiplexer 504 multiplexes the closed-caption TS data sent from the TS demultiplexer 102, the re-encoded video TS data sent from the converter 512, and the TS data other than the video TS data and the closed-caption TS data, which is sent from the TS demultiplexer 511, on a packet-by-packet basis. Then, the TS multiplexer 504 outputs the multiplexed data to the network transmitter.

Other than the TS data, the data converter 506 may convert data of a radio broadcast or an FM broadcast to TS data, or may convert an image, which is obtained by combining photograph data with video data captured by a video camera like a slide show, to TS data.

FIG. 6 illustrates another variation of the partial configuration of the server apparatus of FIG. 1. A server apparatus 600 of FIG. 6 includes a broadcast receiver 101, a TS demultiplexer 102, a storage medium 103, a TS multiplexer 104, a network transmitter 105, and a language converter 606.

In FIG. 6, the language converter 606 decodes the closed-caption TS data sent from the TS demultiplexer 102 to generate character information, and converts the information to another language. Then, the language converter 606 re-encodes the information to generate closed-caption TS data. The closed-caption TS data, which has been converted to the other language, is output to the TS multiplexer 104.

Where the language converter 606 does not include the code of the converted characters, the characters may be expressed as an image and may be encoded as a caption.

While the language converter 606 converts the closed-caption TS data, the conversion target is not limited to a caption, but may be audio data or closed-caption data as long as the language can be converted.

As long as the server apparatus has the functions of receiving digital broadcasts and sending DLNA, the functions described in this embodiment may be implemented without adding any particular dedicated function. Similarly, as long as the terminal apparatus has the function of receiving DLNA, the functions described in this embodiment can be implemented without having communications function exclusively for receiving emergency information.

While, in this embodiment, a digital television broadcast is used as an example, the present disclosure is not limited thereto. Additional information may be widely used in a digital radio, a digital audio broadcast (DAB), etc. In accessing not only DLNA at home but also the outside, using a terminal apparatus, the additional information of multiplexed received data can be widely used not only in a digital television broadcast but also in a digital radio, a DAB, etc.

### Second Embodiment

### Configuration

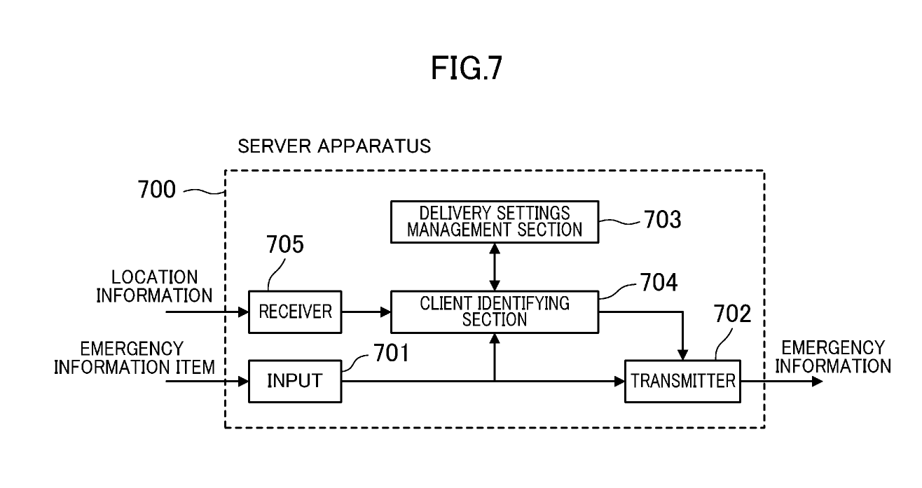

FIG. 7 illustrates a schematic configuration of a server apparatus according to this embodiment. A server apparatus 700 of FIG. 7 delivers a received emergency information item to a client (e.g., a terminal apparatus) meeting predetermined requirements. In FIG. 7, an input 701 receives an emergency information item from the outside of the server apparatus 700. The emergency information item is, for example, additional information expressed by characters or a sound included in a digital television broadcast. Alternatively, additional information in a digital radio, a DAB, etc. may be used.

A delivery settings management section 703 manages delivery settings of emergency information for each of clients registered in the server apparatus 700. A client identifying section 704 refers to the delivery settings managed by the delivery settings management section 703, and identifies, among the registered clients, a client to which the emergency information item received by the input 701 is to be delivered. A transmitter 702 sends, as the emergency information, the emergency information item received by the input 701 to the client identified by the client identifying section 704. The receiver 705 also receives location information indicating the actual location of the client such as GPS information. The location information is used for identifying the client to which the emergency information is to be delivered.

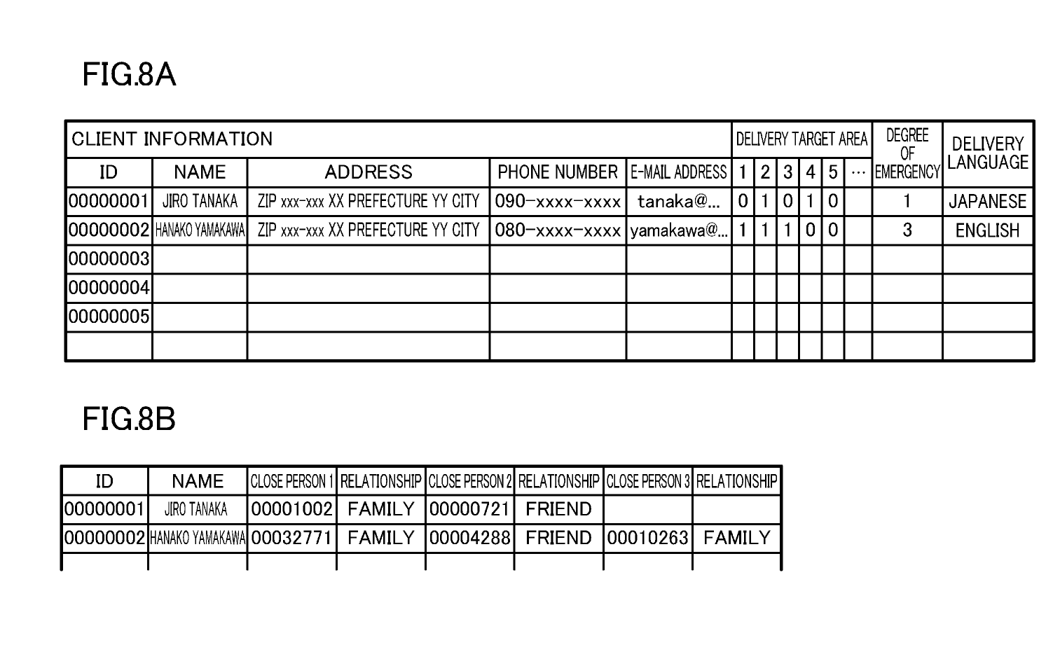

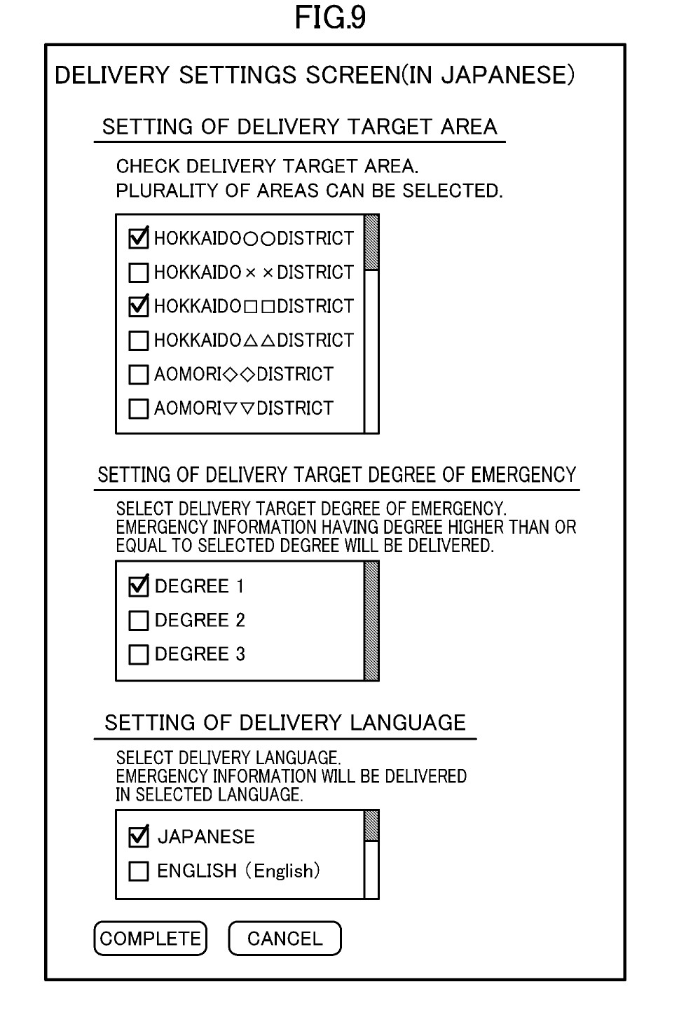

FIGS. 8A and 8B illustrate example delivery settings managed by the delivery settings management section 703. FIG. 8A illustrates example fundamental delivery settings. Clients are managed using IDs. The names, addresses, phone numbers, and e-mail addresses for delivery of users are registered as client information. For each of the clients, a delivery target area, a degree of urgency, and a delivery language can be set. Each user performs delivery settings using the delivery settings screen as shown in FIG. 9 displayed in the terminal apparatus.

The delivery target area is the target area for which emergency information a client wishes to receive. An emergency information item associated with the selected area is delivered to the client. For example, the area for an emergency information item wished to receive can be registered by a region-by-region basis such as Kanto region and Kinki region, or a prefecture-by-prefecture basis such as Hokkaido and Aomori. This allows each client to receive emergency information of an area other than the residence and the actual location.

The degree of urgency is the degree of urgency of the emergency information which a client wishes to receive. An emergency information item having the degree of urgency which is higher than or equal to the selected degree of urgency is delivered to the client. The degree of urgency may be set for each delivery target area. The delivery language is the language of the emergency information which the client wishes to receive. The emergency information is converted to the selected language and is then delivered.

FIG. 8B illustrates example settings of a person close to each client. For each client, information on the close person client is registered. The close person client is a client of the close person, of which safety is wished to know in an emergency. The information is, for example, the ID, the relationship with the client, etc. Each user can register or change the information on the close person using the settings screen of the terminal apparatus. By managing the close person client, as will be described below, when the location information of the close person client is included in the area associated with an emergency information item, the service of sending emergency information can be provided, regardless of the delivery settings of the client.

### Operation

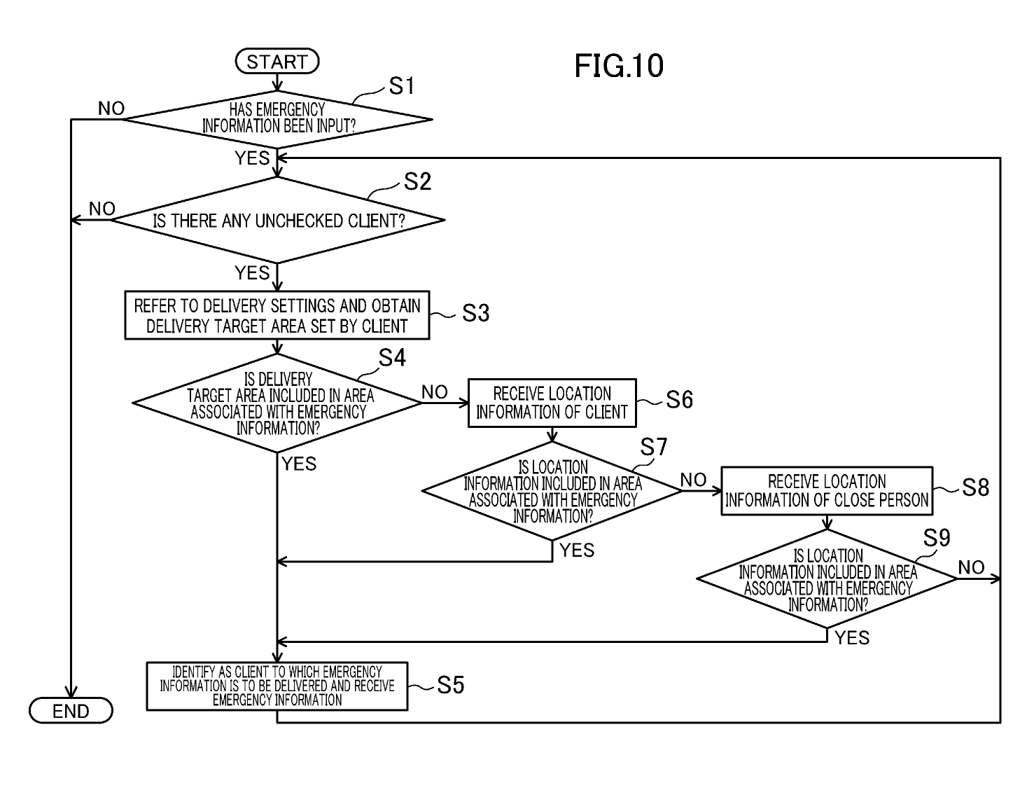

FIG. 10 is a flow chart illustrating example operation of the server apparatus 700. As shown in FIG. 10, when the input 701 receives an emergency information item (YES in S1), the server apparatus 700 executes checking of whether or not the emergency information item is to be delivered to each of the registered clients (S2). First, about the client to be checked, the server apparatus 700 refers to the delivery settings managed by the delivery settings management section 703, and obtains information on the delivery target area set by the client (S3). If the delivery target area is included in the area associated with the emergency information (YES in S4), the server apparatus 700 identifies the client as a client to which the emergency information is to be delivered, and send the emergency information to the client (S5).

On the contrary, if the delivery target area is not included in the area associated with the emergency information (NO in S4), the receiver 705 receives the location information of the client (S6). If the actual location of the client, which is indicated by the received location information, is included in the area associated with the emergency information (YES in S7), the server apparatus 700 identifies the client as a client to which the emergency information is to be delivered, and send the emergency information to the client (S5). If the actual location is not included in the area associated with the emergency information (NO in S7), the receiver 705 receives the location information of the close person client (S8). The close person client is identified by referring to the setting of the close person managed by the delivery settings management section 703. If the actual location of the close person client, which is indicated by the received location information, is included in the area associated with the emergency information (YES in S9), the server apparatus 700 identifies the client as a client to which the emergency information is to be delivered, and send the emergency information to the client (S5). If not, delivery is not made and the process proceeds to checking of the next client.

While, in the operational flow chart of FIG. 10, the determination is made in the order of the delivery target area, the location information of the client, and the location information of the close person client, the order of determination is not limited thereto. For example, determination using the location information of the client may be made first.

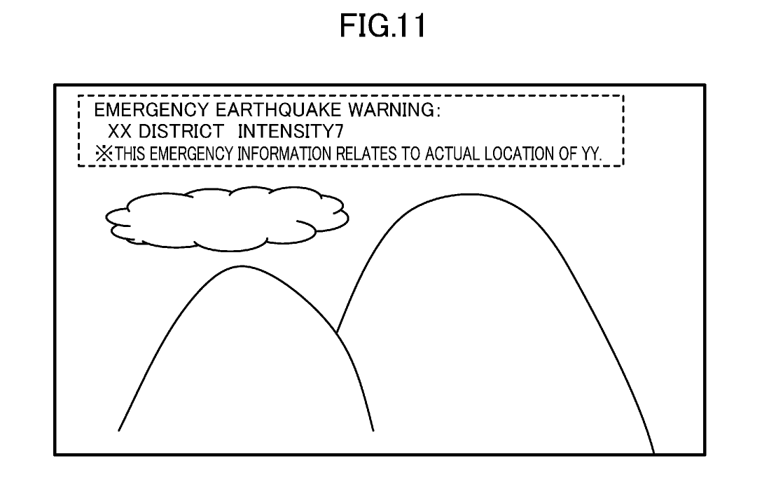

FIG. 11 is an example display of the terminal apparatus to which emergency information is delivered. FIG. 11 illustrates the emergency information for the actual location of Mr. YY, who is close to the user of this terminal apparatus. This allows the user to know the emergency information for the actual location of the person, of which safety the user wishes to know.

### Advantages

As described above, in this embodiment, the server apparatus 700, which delivers emergency information to a client, includes the input 701 receiving an emergency information item, the delivery settings management section 703, the client identifying section 704, and the transmitter 702. The delivery settings management section 703 manages delivery settings of emergency information for each of registered clients. The client identifying section 704 refers to the delivery settings managed by the delivery settings management section, and identifies, among the registered clients, a client to which the emergency information item received by the input 701 is to be delivered. The transmitter 702 sends the emergency information item received by the input 701 to the client identified by the client identifying section 704.

As such, the server apparatus sends the input emergency information item to the client identified based on the delivery settings of emergency information. As a result, the emergency information is accurately delivered to the client of the user, who wishes to receive the information.

In this embodiment, a delivery target area of emergency information, which the client wishes to receive, can be set for each of the registered clients at the delivery settings management section 703. Where the target area set at the delivery settings management section 703 is included in the area associated with the emergency information item, the client identifying section 704 identifies the client as a client to which the emergency information item is to be delivered. As a result, the emergency information for the target area is accurately delivered to the client of the user, who wishes to receive the information.

In this embodiment, the receiver 705 receives location information indicating the actual location of a client. Where the actual location of the client indicated by the location information, which has been received by the receiver 705, is included in the area associated with the emergency information item, the client identifying section 704 identifies the client as a client to which the emergency information item is to be delivered. As a result, the emergency information for the actual location of the client is accurately delivered to the client.

In this embodiment, a close person client can be set for each of the registered clients at the delivery settings management section 703. Where the actual location of the close person client indicated by the location information, which has been received by the receiver 705, is included in the area associated with the emergency information item, the client identifying section 704 identifies the client as a client to which the emergency information item is to be delivered. As a result, the emergency information for the actual location of the person close to the client is accurately delivered to the client who wishes to receive the information on the safety of the person.

### Other Embodiments

As described above, the first to second embodiments have been described as example techniques disclosed in the present application. However, the techniques according to the present disclosure are not limited to these embodiments, but are also applicable to those where modifications, substitutions, additions, and omissions are made. In addition, elements described in the first to second embodiments may be combined to provide a different embodiment.

Other exemplary embodiments will be described below.

While, in the first embodiment, the TS data is separated from the digital broadcast signal to be multiplexed with the other data, the present disclosure is not limited thereto. The present disclosure is applicable to any configuration, as long as a stream of a predetermined type can be separated from a digital broadcast signal and multiplexed.

In the second embodiment, determination based on the degree of urgency may be added to the operational flow chart of FIG. 10. For example, before step S3, the degree of urgency set by a client may be obtained, and whether or not the degree of urgency of the emergency information item is higher than or equal to the set degree of urgency may be determined. If the degree of urgency of the emergency information item is higher than or equal to the set degree of urgency, the process may proceed to the next step. If not, the process may proceed to checking of the next client. As a result, only the emergency information having the degree of urgency, which the user wishes to receive, is accurately delivered to the client.

In the second embodiment, when the emergency information is sent in step S5, the delivery language may be set with reference to the delivery settings managed by the delivery settings management section 703. For example, if an emergency information item is in Japanese, and English is set as the delivery language, the emergency information item is converted to English and sent. As a result, the emergency information is delivered to the client in the desired language, thereby improving the convenience for the user.

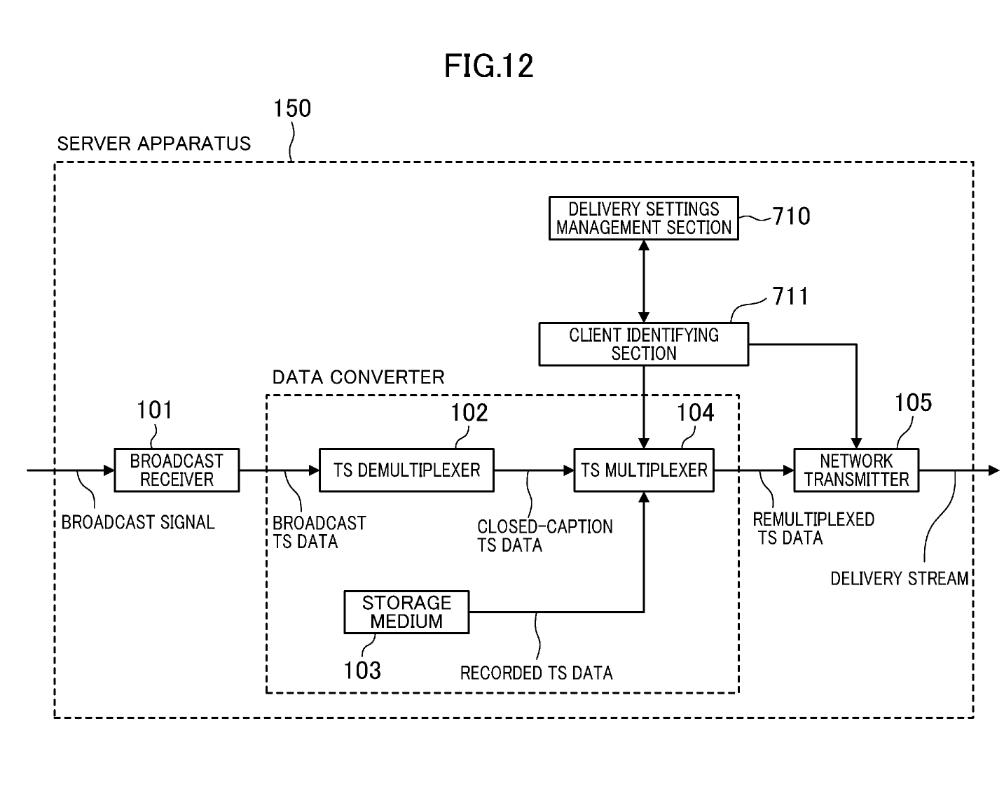

The first embodiment and the second embodiment may be implemented in combination. FIG. 12 illustrates a schematic configuration of a server apparatus according to the combination of the first and second embodiments. A server apparatus 150 of FIG. 12 includes a delivery settings management section 710 and a client identifying section 711 in addition to the configuration of FIG. 1. The delivery settings management section 710 and the client identifying section 711 are similar to the delivery settings management section 703 and the client identifying section 704 in the second embodiment. The delivery settings management section 710 manages delivery settings of emergency information for each of clients registered in the server apparatus 150. The client identifying section 711 refers to the delivery settings managed by the delivery settings management section 710, and identifies, among the registered clients, a client to which an emergency information item separated from a broadcast signal is to be delivered. A network transmitter 105 sends the emergency information item to the client identified by the client identifying section 711.

Various embodiments have been described above as example techniques of the present disclosure, in which the attached drawings and the detailed description are provided.

As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

Since the embodiments described above are intended to illustrate the techniques in the present disclosure, it is intended by the following claims to claim any and all modifications, substitutions, additions, and omissions that fall within the proper scope of the claims appropriately interpreted in accordance with the doctrine of equivalents and other applicable judicial doctrines.

The present disclosure is applicable to a server apparatus delivering input emergency information to a client, or a user, who wishes to receive the information. Specifically, the present disclosure is applicable to a server apparatus etc. which receives a digital broadcast such as a digital television broadcast, a digital radio, and DAB, and notifies emergency information to a terminal apparatus.

What is claimed is:

1. A server apparatus delivering emergency information to a client, the server apparatus comprising:
a delivery settings management section configured to manage delivery settings of the emergency information for each of registered clients;
an input configured to receive an emergency information item;
a client identifying section configured to refer to the delivery settings managed by the delivery settings management section, and to identify, among the registered clients, a first client to which the emergency information item received by the input is to be delivered; and
a transmitter configured to send the emergency information item to the first client identified by the client identifying section.

2. The server apparatus of claim 1, wherein
the delivery settings management section is configured to set a target area for the emergency information wished to receive for each of the registered clients, and
the client identifying section identifies a registered client for which the target area, which is set at the delivery settings management section, is included in an area associated with the emergency information item, as the first client.

3. The server apparatus of claim 1, further comprising
a receiver configured to receive location information indicating an actual location of each of the registered clients, wherein
the client identifying section identifies a registered client of which the actual location, which is indicated by the location information received by the receiver, is included in an area associated with the emergency information item, as the first client.

4. The server apparatus of claim 1, further comprising
a receiver configured to receive location information indicating an actual location of each of the registered clients, wherein
the delivery settings management section is configured to set a close person client which is a client of a close person whose safety is wished to know for each of the registered clients, and
the client identifying section identifies a registered client for which the actual location of the close person client, which is indicated by the location information received by the receiver, is included in an area associated with the emergency information item, as the first client.

5. The server apparatus of claim 1, wherein
the delivery settings management section is configured to set a language of the emergency information wished to receive for each of the registered clients, and
the transmitter converts the emergency information item into the language set at the delivery settings management section for the registered client.

6. The server apparatus of claim 1, wherein
the delivery settings management section is configured to set a degree of urgency of the emergency information wished to receive for each of the registered clients, and
the client identifying section identifies a registered client, for which a degree of urgency of the emergency information item is higher than or equal to the degree of urgency, which is set at the delivery settings management section, as the first client.

7. The server apparatus of claim 1, wherein
the emergency information includes a flash report on or a warning about a natural disaster.

8. A server apparatus comprising:
a broadcast receiver configured to receive a digital broadcast signal;
a separator configured to separate a stream of a predetermined type from the digital broadcast signal;
a multiplexer configured to multiplex the stream of the predetermined type, which has been separated by the separator, with another stream different from the digital broadcast signal; and
a network transmitter configured to send the stream multiplexed by the multiplexer over a wired or wireless network.

9. The server apparatus of claim 8, wherein
the stream of the predetermined type is a caption.

10. The server apparatus of claim 9, wherein
the separator separates the caption indicating emergency information including a flash report on or a warning about a natural disaster, as the stream of the predetermined type.

11. A terminal apparatus receiving a multiplexed stream from a server apparatus and reproducing the multiplexed stream, wherein the server apparatus includes
a separator separating a stream of a predetermined type from a digital broadcast signal,
a multiplexer multiplexing the stream of the predetermined type, which has been separated by the separator, with another stream different from the digital broadcast signal, and
a network transmitter sending the stream multiplexed by the multiplexer over a wired or wireless network,
the terminal apparatus comprising:
a network receiver configured to receive the multiplexed stream from the network; and
a superimposer configured to superimpose the stream of the predetermined type on a display image of the multiplexed stream received by the network receiver, wherein [symbol]
